(19) United States
(12) Patent Application Publication
(10) Pub. No.: US 2004/0211297 A1
(43) Pub. Date: Oct. 28, 2004

(54) Tong piston and cylinder assembly

(76) Inventor: Daniel S. Bangert, Broussard, LA (US)

Correspondence Address: Jones, Walker, Waechter, Poitevent,, Carrere & Denegre, L.L.P., Four United Plaza, 4th Floor, 8555 United Plaza Boulevard, Baton Rouge, LA, 70809, US

(21) Appl. No.: 10/421,041

(22) Filed: Apr. 23, 2003

(51) Int. Cl. B25B 17/00

(52) U.S. Cl. 81/57.15

(57) ABSTRACT

A power tong having an improved piston and cylinder assembly comprising retraction springs that are located inside the cylinder.

### BACKGROUND OF THE INVENTION

A. Field of the Invention

The present invention relates to pipe tongs or power tongs used in the oil and gas industry to make-up and break-out sections of drill pipe and other tubular members having threaded connections. More particularly, the present invention relates to a novel piston cylinder assembly for use in power tongs.

B. Description of the Related Art

Power tongs are often employed in the oil and gas industry to break-out or make-up threaded tubular member connections. It is generally required that one tong grip and rotate one section of a tubular string and a second tong grip and hold stationary the other section of the tubular string. The first tong rotating the first tubular member is typically referred to as the power tong, while the second tong holding the second tubular member stationary is typically referred to as the back-up power tong. Modern drilling operations usually employ power tongs to grip and rotate tubulars such as drill pipe, tubing, or casing. Examples of conventional power tongs can be seen in references such as U.S. Pat. Nos. 5,671,961, 5,702,139, and 5,819,604 to Buck, which are incorporated herein by reference.

One of the more specialized uses of power tongs is for gripping special alloy tubing or casing (normally an alloy of stainless steel) without leaving indentations or gripping marks which may tend to jeopardize the structural integrity of these costly tubulars. Rather than using convention and rather aggressive jaw tooth patterns, it is desirable to grip these alloy tubulars with smooth faced jaws or jaws with specialty surfaces such as seen in U.S. Pat. No. 6,378,399 to Bangert. However, when gripping a tubular with specialty surface jaws, it is often necessary to apply a greater and more controlled compressive load. This is often accomplished by driving the jaws with hydraulic cylinders as opposed to the more typical power tong which drives the jaws with cam surfaces such as seen in U.S. Pat. Nos. 4,986,146 and 5,435,213 to Buck which are incorporated by reference herein. One example of a power tong where the jaw members are hydraulically driven-i.e., hydraulic cylinders having pistons drive the jaw members radially inward against the tubular is seen in the Chromemaster™ power tong modification assembly sold by Superior Manufacturing and Hydraulics, Inc., of Broussard, La. To release the tubular, the hydraulic fluid is allowed to bleed out of the cylinder, allowing the jaw member to be retracted away from the tubular by a biasing device, such as retraction springs, as the fluid escapes. The retraction springs are typically located externally to the hydraulic cylinder and, therefore, are exposed to the corrosive oil field environment. Such exposure over time can degrade the ability of the springs to properly retract the jaw member. Additionally, because the retraction springs are located externally, it is often difficult to find sufficient space to mount the springs. Thus, the retraction springs are typically positioned at an angle to the axis on which the piston moves, which in turn reduces the amount of force the retraction springs exert on the piston. Even with the angled arrangement, the external retraction springs take up enough space to limit the number of hydraulically biased jaw members that may be used in one power tong.

FIGS. 1a and 1b depict an example of a prior art power tong 200 employing the external, angled retraction spring arrangement discussed above. For purposes of simplification, many conventional details such has hydraulic lines and the power tong motor are not shown in the Figures. The power tong generally comprises a pair of pivoting jaw members 208a and 208b (shown in their closed positions), which are usually pivoted together and locked to enclose a tubular (not shown) positioned within a center aperture 207. To the rear of the center aperture 207, there is a radially movable jaw member 202. The jaw member 202 forms part of a hydraulic cylinder 201. The pivoting jaw members 208a and 208b and the radially movable jaw member 202 are fixed to a ring gear 214, which rotates within the power tong body 213 and allows the pivoting jaw members 208a and 208b and the radially movable jaw member 202 to apply torque to the tubular.

The jaw member 202 is attached to a stationary back plate 203 by retraction springs 204. One end of each retraction spring 204 is attached to the jaw member 202 with a pin 205, and the other end of each retraction spring 204 is attached to the back plate 203 by clipping onto an ear 206. As suggested by FIG. 1b, there are two retraction springs 204 on each side of the hydraulic cylinder 201. Each retraction spring 204 is positioned at an angle to the axis that the jaw member 202 moves along. As shown in FIG. 1c, the hydraulic cylinder 201 comprises a cylinder barrel 209 formed within the interior of the jaw member 202. A piston 210 is positioned within the cylinder barrel 209 and one end of the piston 210 is fixed to the back plate 203. The piston 210 also has a fluid channel 211 through its center which allows hydraulic fluid to flow into a space 212 between the piston 210 and the end of the cylinder barrel 209. As hydraulic fluid is added to the interior of the hydraulic cylinder 201, the pressure accumulating within the hydraulic cylinder 201 causes the jaw member 202 to move forward toward the tubular member because the piston 210 is fixed against the back plate 203. The movement of the jaw member 202 extends the retraction springs 204.

As hydraulic fluid is released from the interior of the hydraulic cylinder 201, pressure decreases within the hydraulic cylinder 201, which allows the retraction springs 204 to contract, which in turn causes the jaw member 202 to retract.

What is needed in the art is a power tong piston and cylinder assembly that reduces the amount of space used by the retraction springs and that does not subject the retraction springs to the corrosive oil field environment. It would also be a significant improvement in the art to provide a power tong piston and cylinder assembly whose geometry allows for additional springs to act on the jaw member and allows those springs to act in a direction parallel to the movement of the jaw member, thereby increasing the retracting force the springs apply to the jaw member.

### BRIEF SUMMARY OF THE INVENTION

The present invention provides a power tong having an improved piston and cylinder assembly comprising retraction springs that are located inside the cylinder.

### BRIEF DESCRIPTION OF THE SEVERAL VIEWS OF THE DRAWINGS

FIG. 1a is a top view of a prior art power tong comprising an external retraction spring arrangement.

FIG. 1b is a side view of the prior art power tong in FIG. 1a illustrating an external retraction spring arrangement.

FIG. 1c is an enlarged cut-away view of the hydraulic cylinder in the prior art power tong in FIGS. 1a and 1b.

FIG. 2 is an exploded perspective view of a power tong piston and cylinder assembly according to the present invention.

FIG. 3 is an top view of a power tong comprising two piston and cylinder assemblies according to the present invention.

FIG. 4 is a schematic illustration of the hydraulic system used to control the flow of hydraulic fluid to and from the piston and cylinder assembly in a power tong according to the present invention.

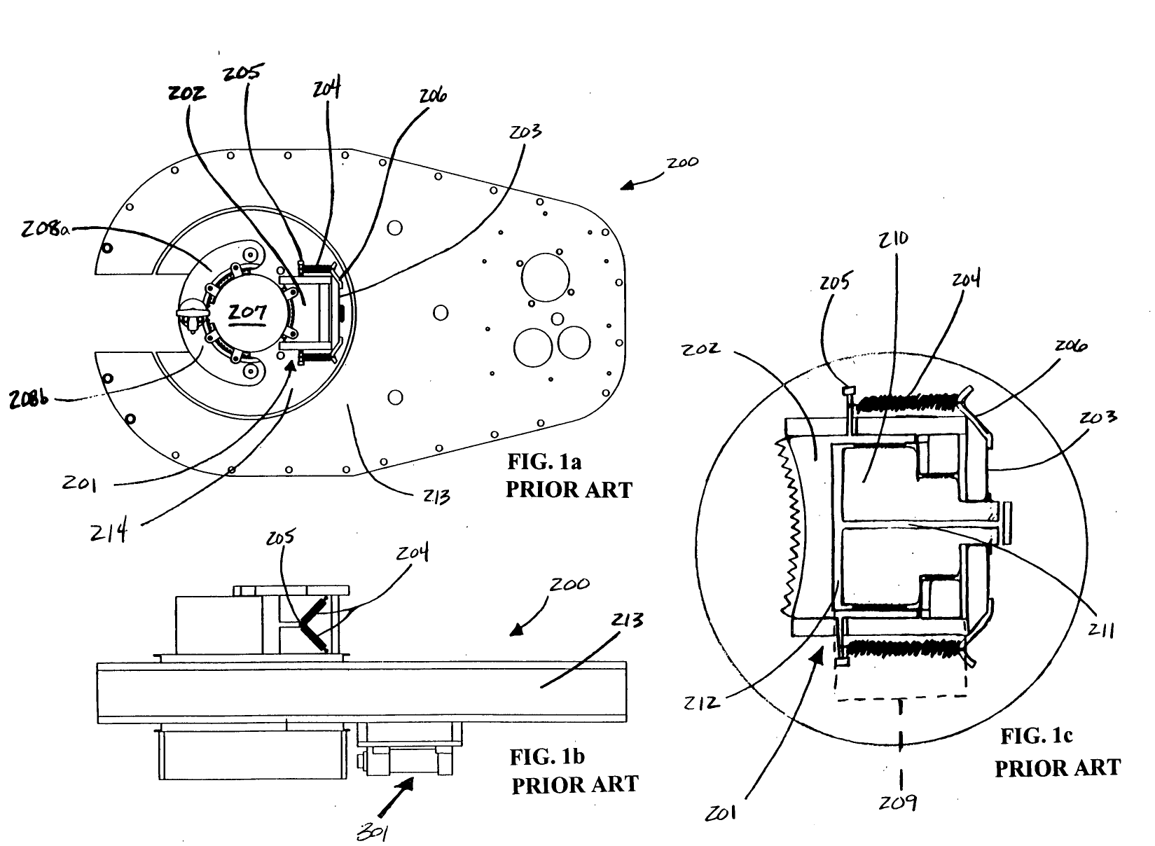

### Detailed Description of the Invention

The following detailed description refers to the accompanying figures.

The term “power tong” as used herein refers to both power tongs for rotating tubular members and back-up power tongs for holding tubular members stationary against rotation.

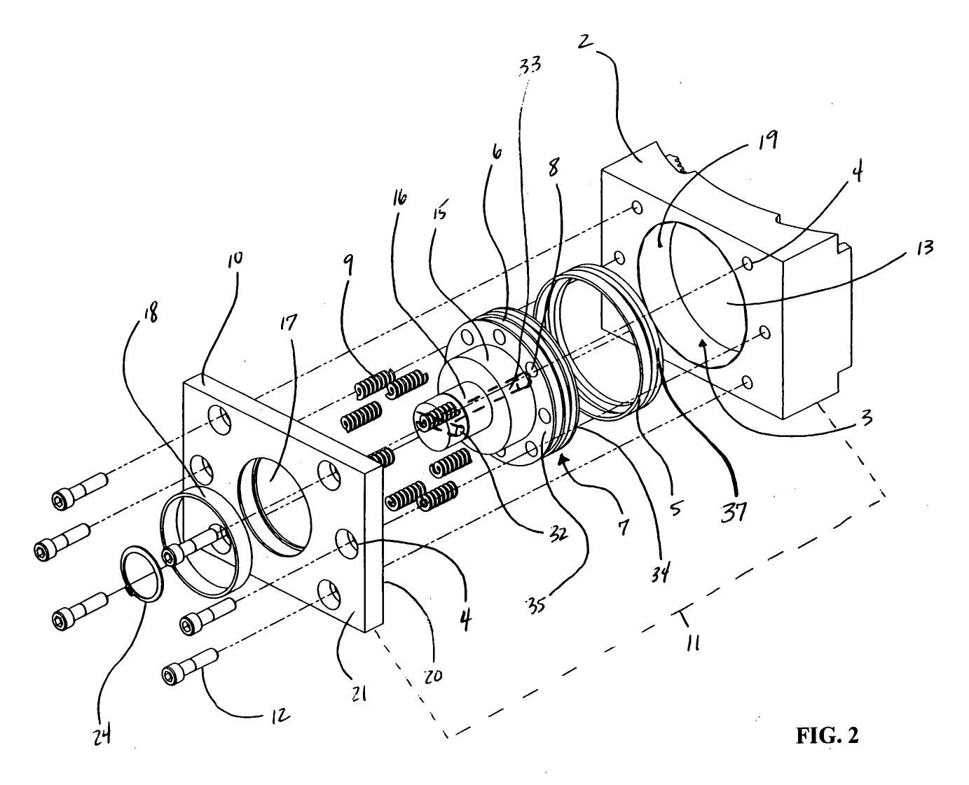

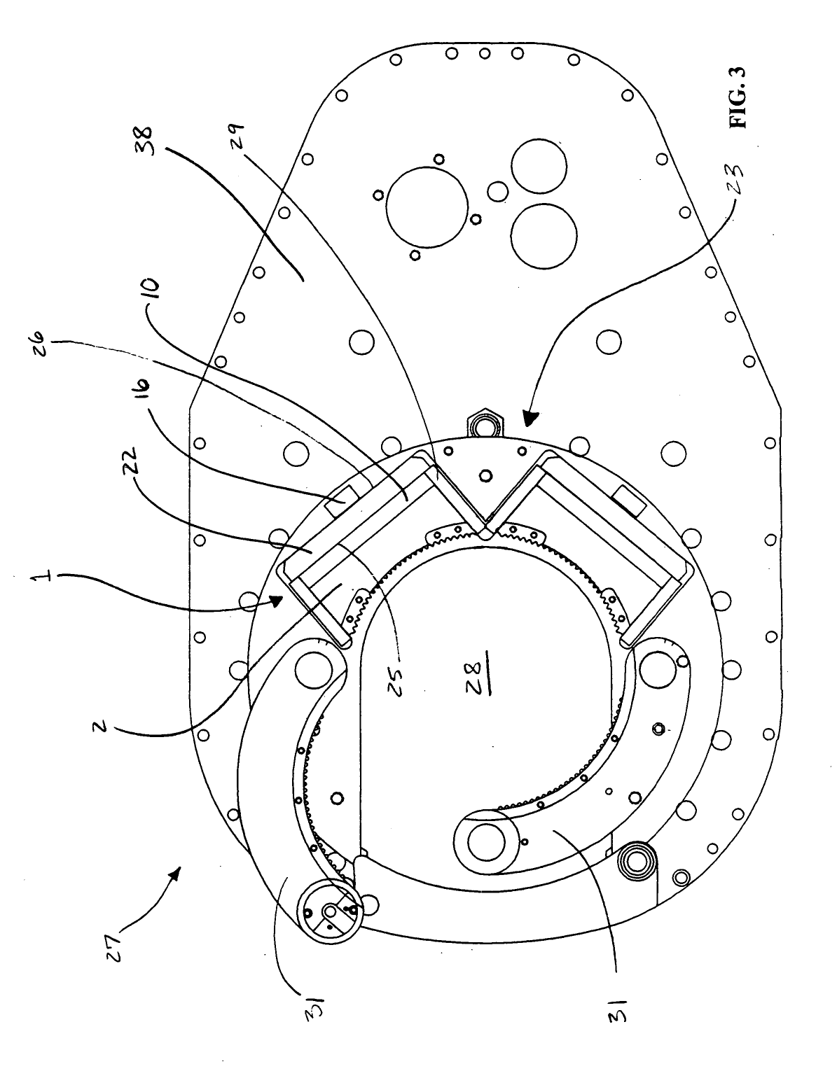

In one embodiment, the present invention consists of a power tong 27 having a piston and cylinder assembly 1 as seen in FIGS. 2 and 3. The piston and cylinder assembly includes a cylinder housing 11 comprising a front portion made up of a jaw member 2, and a back portion made up of a gland cap 10. The piston and cylinder assembly 1 is integrally formed with the jaw member 2. The gland cap 10 has a front 20 and a back 21 and is secured to the jaw member 2 using a plurality of bolts 12. Inside the cylinder housing 11 is a piston 7 having a head 6, a body 15, and a rod 16. The piston head 6 has a front 34 and a back 35.

The jaw member 2 forms a cylinder-shaped barrel 3, having a front 13 and a cylindrical side 19. The front 13 and side 19 of the barrel 3 are formed by the interior surface of the jaw member 2. Positioned inside the barrel 3, are a seal 37, a first piston bearing 5, and the piston head 6. The seal 37 and the first piston bearing 5 are positioned between the sides of the piston head 6 and the side 19 of the barrel 3. The seal 37 prevents hydraulic fluid from flowing out of the barrel 3. The first piston bearing 5 is a ring constructed of a non-metal material (for example, nylon material) to prevent metal on metal contact between the surface of the piston head 6 and the inner surface of the barrel 3.

The jaw member 2 also includes a plurality of threaded bolt holes 4. A plurality of bolts 12 extend through the bolt holes 4 in the gland cap 10 to the bolt holes 4 in the jaw member 2, thereby securing the gland cap 10 and the jaw member 2 to each other. While the springs 9 seen in the figures are coiled, metal springs, other types of springs, including but not limited to elastic polymer materials, are within the scope of the present invention.

The piston head 6 includes a plurality of retraction spring bore holes 8 arranged in a circular pattern. A plurality of retraction springs 9 are partially positioned inside the retraction spring bore holes 8. The retraction springs 9 are also partially positioned inside corresponding retraction spring bore holes (not pictured) formed in the hidden side of the gland cap 10. The retraction springs 9 are arranged such that when they are in compression, the springs 9 act to push the piston head 6 and the gland cap 10 away from each other.

The gland cap 10 forms a piston hole 17 in which are positioned the piston body 15 and a second piston bearing 18. The second piston bearing 18 is positioned between the surface of the piston body 15 and the interior surface of the piston hole 17, thereby preventing metal on metal contact between the piston body 15 and the gland cap 10.

The piston rod 16 extends through the piston hole 17 and through a back plate 22, as can be seen in FIG. 3. The back plate 22 has a front side 25 and a back side 26, and includes a piston rod hole (not pictured) through which the piston rod 16 extends. The back plate 22 is immobile and is secured to a ring gear 23 as is commonly found in the art. A snap ring 24 (see FIG. 2) is secured to the piston rod 16 on the back side 26 of the back plate 22, thereby preventing the piston 7 from moving in the direction of the front side 25 of the back plate 22.

As shown in FIG. 2, the piston rod 16 includes a fluid port 32 which leads to a fluid channel 33, which travels through the center of the piston rod 16, the piston body 15, and the piston head 6, along the longitudinal axis. Hydraulic fluid is able to pass into the fluid port 32, through the fluid channel 33, and into the barrel 3 as is described further below in reference to the power tong piston and cylinder assembly's 1 operation.

Because of the internalization of the retraction springs, more than one power tong piston and cylinder assembly may be incorporated into a power tong. In one embodiment of the present invention, as seen in FIG. 3, the power tong 27 comprises two such piston and cylinder assemblies 1. Each cylinder housing 11 is enclosed by side plates 29 and a back plate 22, which are secured to the ring gear 23 by welding, bolts, or other conventional means.

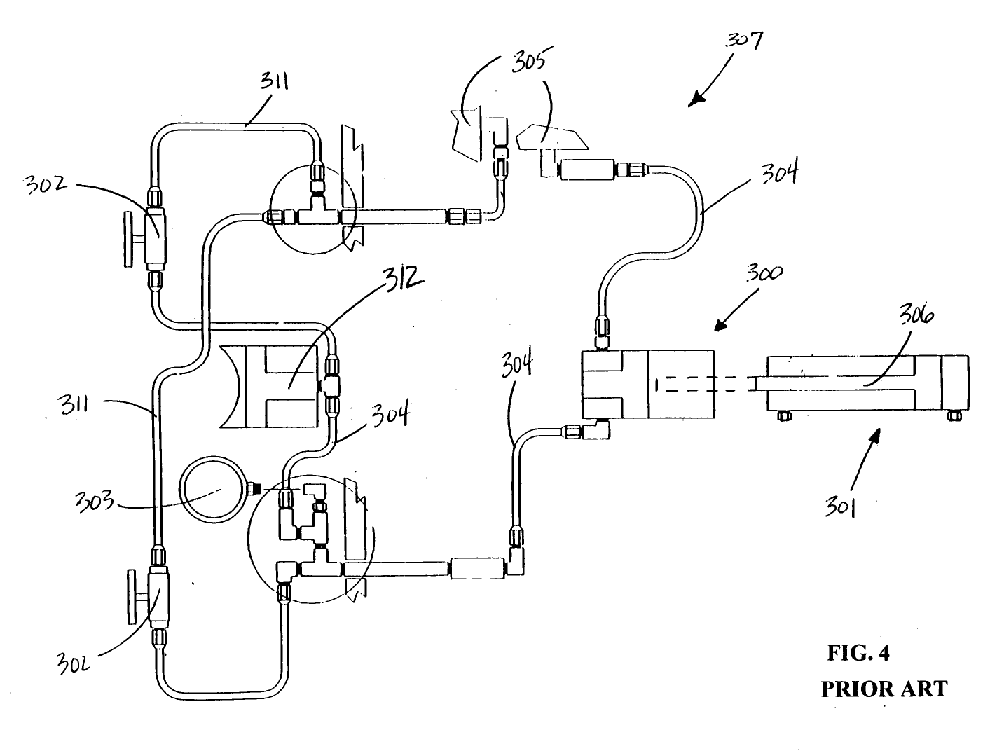

In operation, the power tongs of the present invention are used to grip tubular members, for example, a length of tubing or casing. The tubular (not pictured) is placed in the center aperture 28. The pair of pivoting jaws 31 are interlocked, thereby enclosing the tubular. Hydraulic fluid is then pumped into the fluid port 32, through the fluid channel 33, and into the barrel 3. The flow of hydraulic fluid to and from the power tong piston and cylinder assembly 1 is typically regulated through a hydraulic system known in the art, such as the system 307 (illustrated in FIG. 4) used in the Chromemaster™ power tong modification assembly referenced above.

As shown in FIG. 4, a hydraulic pump cylinder 301 includes a piston 306. The hydraulic pump cylinder 301 is mounted on a rearward bottom section of the power tong body 38 and not on the ring gear 23 (see FIG. 3). Therefore, the hydraulic pump cylinder 301 and the piston 306 do not rotate with the ring gear 23. When the piston 306 is extended, it mechanically engages (and thereby activates) an intensifier pump 300. The intensifier pump 300 is mounted on the ring gear 23 and rotates with the ring gear 23. While not explicitly shown, it will be understood that hydraulic lines travel through the ring gear 23 and the other rotating elements of the power tong 27 in order to supply hydraulic fluid from the intensifier pump 300 to the piston and cylinder assembly 1 (see FIG. 3; the piston and cylinder assembly 1 in FIG. 3 corresponds to the piston and cylinder assembly 312 in FIG. 4). When the ring gear 23 is aligned in the open throat position, the piston 306 and the intensifier pump 300 engage reciprocally, causing the intensifier pump 300 to draw hydraulic fluid from a fluid reservoir 305 and send the fluid through tubing 304 to the fluid port 32 (see FIG. 2), thereby sending pressurized fluid through the fluid channel 33 and into the barrel 3. The pressure in the hydraulic system 307 is measured using a gauge 303 or, alternatively, using circuits known in the art which automatically regulate a predetermined pressure. As the amount of hydraulic fluid increases, pressure accumulates within the barrel 3, which causes the cylinder housing 11 (and therefore, the jaw member 2) to move forward into the center aperture 28, thereby applying a radial load to the tubular. It will be understood that the movement of the jaw member 2 compresses the retraction springs 9.

In order to release the gripping force on the tubular, a hydraulic valve 302 is switched to allow the pressurized fluid to flow through a non-pressurized return line 311 to the fluid reservoir 305. This allows the pressurized fluid in the barrel 3 to bleed out of the piston and cylinder assembly 1. This depressurization of fluid in turn allows the retraction springs 9 to decompress and push the cylinder housing 11 (and therefore, the jaw member 2) back to its retracted position.

While many parts of the present invention have been described in terms of specific embodiments, it is anticipated that still further alterations and modifications thereof will no doubt become apparent to those skilled in the art. For example, the piston and cylinder assembly of the present invention could be used in back-up tongs. Other embodiments are possible and modifications may be made to the embodiments without departing from the spirit and scope of the invention. The preceding detailed description is not meant to limit the invention. Rather, the scope of the invention is defined by the appended claims. It is therefore intended that the following claims be interpreted as covering all such alterations and modifications as fall within the true spirit and scope of the invention.

What is claimed is:

1. A power tong having a piston and cylinder assembly comprising a plurality of retraction springs, said springs being located within said piston and cylinder assembly.

2. The power tong of claim 1, wherein said piston and cylinder assembly is integrally formed with a jaw member.

3. The power tong of claim 2, wherein said springs act in a direction parallel to the movement of said jaw member.

4. The power tong of claim 1, wherein said springs communicate with the piston within said piston and cylinder assembly.

5. The power tong of claim 4, wherein said springs further communicate with a gland cap.

6. The power tong of claim 5, wherein said springs are arranged such that when said springs are in compression said springs act to push said piston and said gland cap away from each other.

7. The power tong of claim 6, wherein the piston within said piston and cylinder assembly comprises a head.

8. The power tong of claim 7, wherein said springs are located in a circular pattern around said head of said piston.

9. The power tong of claim 1, wherein said power tong further comprises a jaw member.

10. The power tong of claim 9, wherein said springs act in a direction parallel to the movement of said jaw member.

11. The power tong of claim 1, wherein the piston within said piston and cylinder assembly comprises a head.

12. The power tong of claim 11, wherein said springs are located in a circular pattern around said head of said piston.

13. A power tong having a rotating ring gear with a center aperture formed therein, said ring gear having a plurality of radially moving jaws positioned thereon.

14. The power tong of claim 13, wherein said radially moving jaws are hydraulically activated.

15. The power tong of claim 14, wherein each of said radially moving jaws includes a cylinder barrel formed therein.

16. The power tong of claim 14, wherein each of said plurality of radially moving jaws includes a piston and cylinder assembly.

17. The power tong of claim 16, further comprising a plurality of retraction springs, said retraction springs being located within said piston and cylinder assembly.

18. The power tong of claim 13, wherein said rotating gear further comprises a plurality of pivoting jaws.

19. A power tong comprising:
a. a ring gear;
b. a plurality of radially moving jaws positioned on said ring gear, each of said jaws having a piston and cylinder assembly, said piston and cylinder assembly further including an internal means for biasing said piston away from a front portion of said cylinder.

20. The power tong of claim 19, wherein said piston and cylinder assemblies are formed integrally with said radially moving jaws.

21. The power tong of claim 19, wherein said internal means for biasing said piston away from said front portion of said cylinder comprises a plurality of retraction springs.

22. The power tong of claim 21, wherein the piston within said piston and cylinder assembly comprises a head, and said springs are located in a circular pattern around said head of said piston.
